(19) United States
(12) Patent Application Publication
(10) Pub. No.: US 2015/0015612 A1
(43) Pub. Date: Jan. 15, 2015

(54) MEDICAL REPORT GENERATING APPARATUS AND MEDICAL IMAGE DIAGNOSIS APPARATUS

(71) Applicants: Kabushiki Kaisha Toshiba, Minato-ku (JP); Toshiba Medical Systems Corporation, Otawara-shi (JP)

(72) Inventors: Tatsuru KUROSAKI, Nasushiobara-shi (JP); Takeshi Sugio, Otawara-shi (JP); Toshie Maruyama, Yaita-shi (JP); Kenshi Nakano, Otawara-shi (JP); Mitsuo Akiyama, Otawara-shi (JP); Katsuyuki Takamatsu, Yaita-shi (JP)

(73) Assignees: Kabushiki Kaisha Toshiba, Minato-ku (JP); Toshiba Medical Systems Corporation, Otawara-shi (JP)

(21) Appl. No.: 14/327,921

(22) Filed: Jul. 10, 2014

(30) Foreign Application Priority Data
Jul. 11, 2013 (JP) 2013-145317

(51) Int. Cl. G06T 11/60

(52) U.S. Cl. CPC G06T 11/60
USPC 345/636

(57) ABSTRACT

A medical report generating apparatus of the present embodiment includes a designation reception unit, an arrangement processor, and a medical report generator, and generates a medical report having an image arrangement region where medical images are arranged. The designation reception unit receives designation of a desired medical image designation from among one or a plurality of medical images acquired by a medical imaging unit. The arrangement processor determines an arrangement position of the desired medical image in the image arrangement region corresponding to an order of the designation of the desired medical image. The medical report generator generates the medical report by arranging the desired medical image at the arrangement position determined by the arrangement processor.

### CROSS-REFERENCE TO RELATED APPLICATION

This application is based upon and claims the benefit of priority from Japanese Patent Application No. 2013-145317, filed Jul. 11, 2013; the entire contents of which are incorporated herein by reference.

### FIELD

The embodiments relate to medical report generating apparatuses and medical image diagnosis apparatuses.

### BACKGROUND

Medical report generating apparatuses for generating a medical report from a result of interpreting medical images obtained through a medical imaging unit by a doctor, and the like, have already been put in practice. The medical report generating apparatuses can generate the medical report by making the doctor, and the like, input information related to a subject and test contents. The medical report generating apparatuses can also generate the medical report by making the doctor, and the like, input the findings on the medical images in a finding input field and the diagnosis result based on the findings in a diagnosis input field.

Further, the medical report generating apparatus can generate the medical report by making the doctor, and the like, paste necessary medical images onto a predetermined image paste field. At this time, the doctor, and the like, have manually pasted desired medical images onto desired positions on a medical report generation screen displayed on a display.

### BRIEF DESCRIPTION OF THE DRAWINGS

FIG. 1 is a block diagram of the outline configuration of a medical image diagnosis apparatus according to a first embodiment.

FIG. 2 is a block diagram of a configuration example of an ultrasound image generator according to the first embodiment.

FIG. 3 is a function block diagram of a configuration example of an operation unit according to the first embodiment.

FIG. 4 is a block diagram of a configuration example of a report display processor according to the first embodiment.

FIG. 5 is a diagram illustrating an example of a medical report generation screen according to the first embodiment.

FIG. 6 is a flow diagram of an arrangement processing example of an ultrasound image onto a medical report by a medical image processor according to the first embodiment.

FIG. 7A is a sequence diagram of an operation example of the medical image diagnosis apparatus according to the first embodiment.

FIG. 7B is a sequence diagram of an operation example of the medical image diagnosis apparatus according to the first embodiment.

FIG. 7C is a sequence diagram of an operation example of the medical image diagnosis apparatus according to a first modified example of the first embodiment.

FIG. 8 is a function block diagram of a configuration example of the operation unit according to a second modified example of the first embodiment.

FIG. 9 is a block diagram of a configuration example of the report display processor according to a second embodiment.

FIG. 10 is a diagram illustrating an example of a condition set by a condition setting unit according to the second embodiment.

FIG. 11 is a flow diagram of an arrangement processing example of ultrasound images onto a medical report by the medical image processor according to the second embodiment.

FIG. 12 is a diagram illustrating an example of a condition set by the condition setting unit according to a third embodiment.

FIG. 13 is a diagram schematically illustrating a medical report display region on the medical report generation screen according to the third embodiment.

FIG. 14 is a flow diagram of an arrangement processing example of ultrasound images onto a medical report by the medical image processor according to the third embodiment.

FIG. 15 is a block diagram of a configuration example of the report display processor of a first modified example of the third embodiment.

FIG. 16 is a flow diagram of an arrangement example of ultrasound images onto a medical report by the medical image processor of the first modified example of the third embodiment.

FIG. 17 is a flow diagram of an arrangement processing example of ultrasound images of a medical report by the medical image processor of a second modified example of the third embodiment.

### DETAILED DESCRIPTION

The medical report generating apparatus of the present embodiment includes a designation reception unit, an arrangement processor, and a medical report generator, and generates a medical report having an image arrangement region where medical images are arranged. The designation reception unit is configured to receive designation of a desired medical image designation from among one or a plurality of medical images acquired by a medical imaging unit. The arrangement processor is configured to determine an arrangement position of the desired medical image in the image arrangement region corresponding to an order of the designation of the desired medical image. The medical report generator is configured to generate the medical report by arranging the desired medical image at the arrangement position determined by the arrangement processor.

Further, the medical report generating apparatus of the present embodiment includes a designation reception unit, an arrangement processor, and a medical report generator, and generates a medical report having an image arrangement region where medical images are arranged. The designation reception unit configured to receive a desired medical image designation from among one or a plurality of medical images acquired by a medical imaging unit. The arrangement processor configured to determine an arrangement position of the desired medical image, which is received by the designation reception unit, in the image arrangement region corresponding to the medical image type. The medical report generator configured to generate the medical report by arranging the desired medical image at the arrangement position determined by the arrangement processor.

The medical report generating apparatus of an aspect of the embodiment comprises a designation unit; a medical imaging unit; and the above medical report generation apparatus.

### First Embodiment

### Medical Image Diagnosis Apparatus

A medical diagnosis apparatus according to a first embodiment is, for example, an ultrasound diagnosis apparatus, an X-ray imaging apparatus, an X-ray CT (computed tomography) apparatus, a MR (magnetic resonance) apparatus, an endoscopes apparatus, or the like. Hereinafter, it describes the case that the medical image diagnosis apparatus is an ultrasound diagnosis apparatus, as an example. That is, an ultrasound image is described as a medical image, as an example. “Images” corresponds to “image data” one on one, so that these may be treated as the same in this specification. In the same way, “medical reports” corresponds to “medical report data” one on one, so these may be treated as the same.

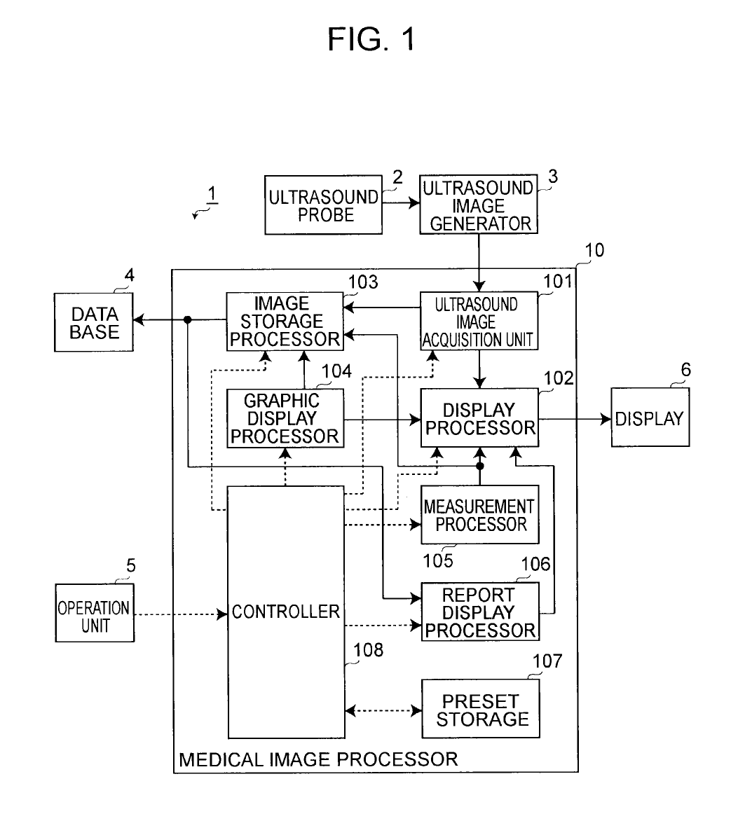

FIG. 1 illustrates a block diagram of the outline configuration of the medical image diagnosis according to the first embodiment. A medical image diagnosis apparatus 1 includes an ultrasound probe 2, an ultrasound image generator 3, a database 4, an operation unit 5, a display 6, and a medical image processor 10.

### (Ultrasound Probe)

As the ultrasound probe 2, either a one-dimensional array probe in which a plurality of ultrasound transducers is arranged in one row in the scanning direction or a two-dimensional array probe in which a plurality of ultrasound transducers is arranged two dimensionally is used. It is also possible to use a mechanical one-dimensional array probe that swings, in the swinging direction perpendicular to the scanning direction, a plurality of ultrasound transducers arranged in one row in the scanning direction. The ultrasound probe 2 transmits ultrasound waves to a subject, and receives the reflected waves from the subject as echo signals by converting the reflected waves into electric signals.

### (Ultrasound Image Generator)

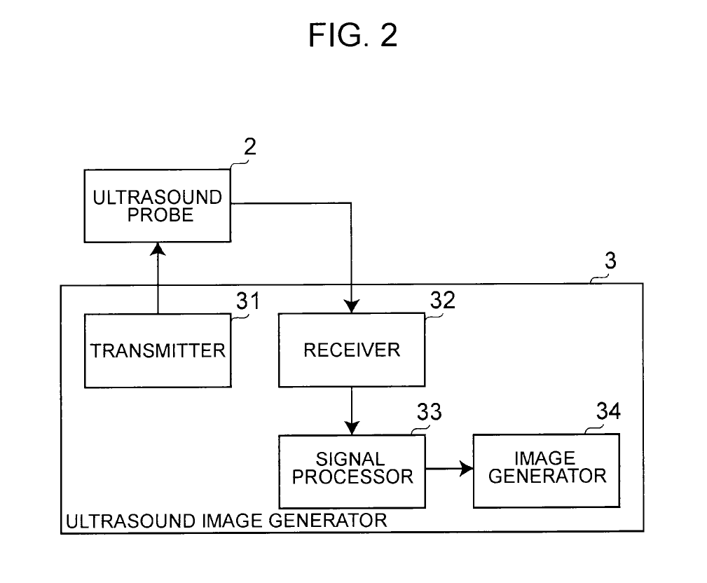

FIG. 2 illustrates a block diagram of a configuration example of the ultrasound image generator 3 according to the first embodiment. The ultrasound image generator 3 includes a transmitter 31, a receiver 32, a signal processor 33, and an image generator 34.

The transmitter 31 supplies electric signals to the ultrasound probe 2, and transmits the ultrasound waves which have been beam-formed into a predetermined focus point (that is, subjected to transmission beam-forming).

The receiver 32 receives the echo signals received by the ultrasound probe 2, and performs delay processing thereon to convert the analog echo signals into phased digital data (that is, subjected to reception beam-forming). The receiver 32 can include, for example, a not-shown preamplifier circuit, an A/D converter, a reception delay circuit, and an adder. The preamplifier circuit amplifies the echo signals output from each ultrasound transducer of the ultrasound probe 2 for each reception channel. The A/D converter converts the amplified echo signals into digital signals. The reception delay circuit provides a delay time required for determining the reception directionality to the echo signals converted into the digital signals. The adder adds the echo signals to which the delay time has been provided. As a result of the addition, a reflective component from a direction corresponding to the reception directionality is enhanced. The received signals output from the receiver 32 are output to the signal processor 32.

The signal processor 33 includes a B-mode processor. The B-mode processor visualizes amplitude information of the received signals upon reception of the received signals from the receiver 32. Specifically, the B-mode processor performs band pass filter processing on the received signals, subsequently detects the envelope of the output signals, and performs compressing processing on the detected data by logarithmic conversion.

The signal processor 33 may include a CFM (Color Flow Mapping) processor. The CFM processor visualizes blood-flow information. The blood-flow information includes information regarding speed, distribution, power, and the like, and is obtained as binary information.

The signal processor 33 may include a Doppler processor. The Doppler processor generates a Doppler frequency distribution representing blood-flow velocity by removing the Doppler shift frequency component by performing phase detection on the received signal to perform FFT (Fast Fourier Transform) processing.

The signal processor 33 outputs the received signals on which the signal processing has been performed (ultrasound raster data) to the image generator.

The image generator 34 generates ultrasound image data (ultrasound raster data) based on the received signals output from the signal processor 23 and subjected to the signal processing. The image generator 34 includes, for example, a DSC (Digital Scan Converter). The image generator 34 converts the received signals represented by a scanning line signal sequence and subjected to the signal processing into image data represented in a perpendicular coordinate system (scan conversion processing). For example, the image generator 34 generates B-mode image data representing the morphology of an organ of the subject by performing scan conversion processing on the received signals that have been subjected to the signal processing by the B-mode processor. The image generator 34 then outputs the ultrasound image data to the medical image data processor 10.

The ultrasound probe 2 and the ultrasound image generator 3 correspond to an example of a “medical imaging unit” according to the present embodiment.

### (Database)

In the database 4 illustrated in FIG. 1, ultrasound images generated based on the echo signals received by the ultrasound probe 2 are stored as medical images. The ultrasound images stored in the database 4 may be provided with diagnosis information, such as annotations, body marks, probe marks, and the like. The database 4 corresponds to an example of a “storage” according to the present embodiment.

### (Operation Unit)

In response to an operation by the doctor, and the like, the operation unit 5 inputs operational information in accordance with the operation contents into the medical image processor 10. The operation unit 5 is configured with pointing devices, such as a joystick, a trackball, and the like, operation switches, operation buttons, operation knobs, or a keyboard. The operation unit 5 may also have a function for receiving an input of signals and information through a network or media.

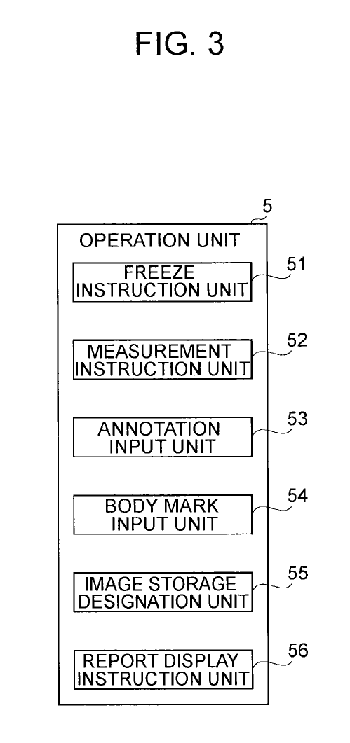

FIG. 3 illustrates a configuration example in which the operation unit 5 of the first embodiment is represented in functional blocks. The operation unit 5 includes a freeze instruction unit 51, a measurement instruction unit 52, an annotation input unit 53, a body mark input unit 54, an image storage designation unit 55, and a report display instruction unit 56. Each of the freeze instruction unit 51, the measurement instruction unit 52, the annotation input unit 53, the body mark input unit 54, the image storage designation unit 55, and the report display instruction unit 56 is configured by any one of the pointing devices, the operation switches, the operation buttons, the operation knobs, or the keyboard.

The freeze instruction unit 51 is used for a user to instruct shifting of the ultrasound probe 2 from the stopped state to the ultrasound scanable state, stopping of an ultrasound image to be displayed on the display 6 in real time, and storing the ultrasound image temporarily in a not-shown storage. The measurement instruction unit 52 is used for the user to instruct start of measuring the inside of the subject with ultrasound waves. The annotation input unit 53 is used for the user to input annotations to be superimposed and displayed on the ultrasound image. The annotation is a text, such as a note, a comment, or the like, and the text may be MR (mitral regurgitation), MS (mitral stenosis), and ASD (atrial septal defect), for example. The body mark input unit 54 is used for the user to input body marks to be superimposed and displayed on the ultrasound image. The body mark is a figure indicating the position or direction of the ultrasound scanning surface of the subject.

The image storage designation unit 55 is used for the user to designate the ultrasound images to be stored in the database 4 each one at a time from among the ultrasound images generated based on the echo signals received by the ultrasound probe 2. The ultrasound image designated by the image storage designation unit 55 is stored in the database 4 along with the related diagnosis information (accessory information), such as the annotations, body marks, and the like, as needed. Further, as described below, the ultrasound image designated by the image storage designation unit 55 together with the related diagnosis information, such as the annotations, body marks, and the like, is arranged within an image arrangement region provided in the medical report.

The arrangement of the image within the image arrangement region in the medical report is realized by pasting the image or providing a link to the image. The pasting of the image is performed by associating the image subjected to the pasting (image data) with an arrangement position within the image arrangement region (layout information of the medical report). For instance, a storage region which has been corresponding to the arrangement position is assigned to the not-shown storage, and the image data of the image subjected to the pasting is stored in the storage region corresponding to the arrangement position. The link to the image is provided by associating address information for referring to the image subjected to the pasting (image data) with the arrangement position within the image arrangement region. For instance, the storage region which has been corresponding to the arrangement position is assigned to the not-shown storage, and the address information for referring to the image data of the image subjected to the pasting is stored in the storage region corresponding to the arrangement position. At this time, the address information is associated with a link text indicating that the link to the image is provided at the arranged position, in a hyper link format. The color of the text is changed in the link correspondence range where the hyper link is set, and an underline is provided to the text to be discriminatingly displayed. The image storage designation unit 55 corresponds to an example of a “designation unit” according to the present embodiment.

The report display instruction unit 56 is used for the user to instruct display of the medical report on the display 6 by a later described report display processor 106.

The operation contents of the user via the operation unit 5 are identified by a controller 108 in the medical image processor 10.

### (Display)

The display 6 is configured by a display device, such as a liquid crystal display, or the like. The display 6 displays various images including ultrasound images and medical reports, and a variety of other information. The display 6 corresponds to an example of a “display” according to the present embodiment.

Each of the ultrasound image generator 3, the database 4, the operation unit 5, and the display 6 configures a part of the medical image diagnosis apparatus 1 in FIG. 1, however, at least a part of the ultrasound image generator 3, the database 4, the operation unit 5, and the display 6 may be arranged in the medical image processor 10. Further, at least a part of the database 4, the operation unit 5, and the display 6 may be arranged outside of the medical image diagnosis apparatus 1, and configured connectably thereto.

### (Medical Image Processor)

The medical image processor 10 controls the operations of each device of the medical image diagnosis apparatus 1. For instance, the medical image processor 10 controls transmission and reception of ultrasound waves for the ultrasound probe 2, and generates ultrasound images based on the echo signals received by the ultrasound probe 2. The medical image processor 10 also performs storage processing and reading-out processing on the ultrasound images with respect to the database 4. Further, the medical image processor 10 controls the operations of each device of the medical image diagnosis apparatus 1 according to the operation content of the user, upon reception of the operation by the user through the operation unit 5. Furthermore, the medical image processor 10 controls processing for generating medical reports and for causing the display 6 to display the generated ultrasound images, the medical reports, and the like.

The medical image processor 10 includes an ultrasound image acquisition unit 101, a display processor 102, an image storage processor 103, a graphic display processor 104, a measurement processor 105, a report display processor 106, a preset storage 107, and the controller 108.

### (Ultrasound Image Acquisition Unit)

Upon the reception of the instruction from the controller 108, the ultrasound image acquisition unit 101 performs processing for acquiring ultrasound data corresponding to the ultrasound images generated by the ultrasound image generator 3, and for outputting the data to the display processor 102 and the image storage processor 103.

### (Display Processor)

Upon the reception of the ultrasound image data from the ultrasound image acquisition unit 101, the display processor 102 causes the display 6 to display the ultrasound images based on the ultrasound image data. The display processor 102 can also cause the display 6 to display various images other than the ultrasound images and a various kind of information other than images. Specifically, the display processor 102 can cause the display 6 to display the ultrasound images on which graphics, such as annotations, body marks, and the like, and measurement results are superimposed. The display processor 102 corresponds to an example of a “display controller” which causes the display 6 to display images.

### (Image Storage Processor)

The image storage processor 103 performs the storage processing to store the ultrasound images (ultrasound image data) displayed on the display 6 in the database 4. The image storage processor 103 stores the ultrasound images designated by the user through the image storage designation unit 55 from among one or a plurality of ultrasound images displayed on the display 6 as well as the diagnosis information thereof in the database 4.

### (Graphic Display Processor)

The graphic display processor 104 outputs, to the display processor 102, pattern data, such as the annotations input or designated by the user through the annotation input unit 53, the body marks input by the user through the body mark input unit 54, and the like. The display processor 102 can cause the display 6 to display the ultrasound images on which graphics, such as the annotations, and the like, are superimposed by synthesizing the ultrasound image data with the pattern data.

The graphic display processor 104 may generate graphic data, as pattern data, corresponding to the text input by the user, and output the generated pattern data to the display processor 102. Otherwise, the graphic display processor 104 may include a graphic memory in which the pattern data including a plurality kind of annotations, body marks, and probe marks are pre-stored, and output the pattern data, such as the annotations input or designated by the user, from the graphic memory.

### (Measurement Processor)

The measurement processor 105 receives an instruction for starting the measurement from the user through the measurement instruction unit 52, and performs measurement processing using a measurement function designated by the user through the operation unit 5 from among the plurality kinds of measurement functions set in advance. The plurality kind of measurement functions includes, for example, a function to measure a length, an area, a volume, and the like, of an organ, or a lesion part, a function to measure a size, and the like, of a region of interest depicted on the ultrasound image, and the like. Such the measurement processor 105 can perform, for example, the designated measurement processing on the still ultrasound image the user has stopped through the freeze instruction unit 51.

### (Report Display Processor)

The report display processor 106 performs processing for causing the display processor 102 to display the processing for generating a medical report and the generated medical report on the display 6. The processing performed by the report display processor 106 is activated when the user instructs. At this time, the report display processor 106 causes the display processor 102 to display the medical report on the display 6 avoid superimposing on the ultrasound image.

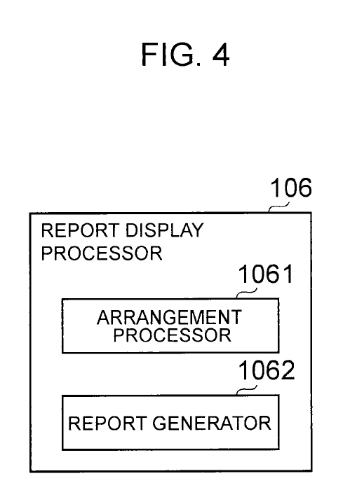

FIG. 4 illustrates a block diagram of a configuration example of the report display processor 106 according to the first embodiment. The report display processor 106 includes an arrangement processor 1061 and a report generator 1062.

The arrangement processor 1061 determines arrangement positions in the image arrangement region provided in the medical report for the ultrasound image designated by the user through the image storage designation unit 55. In the first embodiment, each of the plurality of arrangement positions arranged in advance in the image arrangement region is respectively associated with designated order of the ultrasound images by the image storage designation unit 55. The arrangement processor 1061 determines the arrangement position corresponding to the designated order for the ultrasound image designated by image storage designation unit 55.

The report generator 1062 generates a medical report based on the interpretation result of the ultrasound image by arranging the ultrasound image designated by the image storage designation unit 55 at the arranged position determined by the arrangement processor 1061. At this time, the report generator 1062 causes the display processor 102 to display a medical report generation screen on the display 6. The report generator 1062 receives an entry content entered in a predetermined entry region in the report generation screen, based on the operation input by the user through the operation unit 5, and arranges the designated ultrasound image (including the diagnosis information thereof, as needed) within the predetermined image arrangement region in the medical report generation screen, generating a medical report.

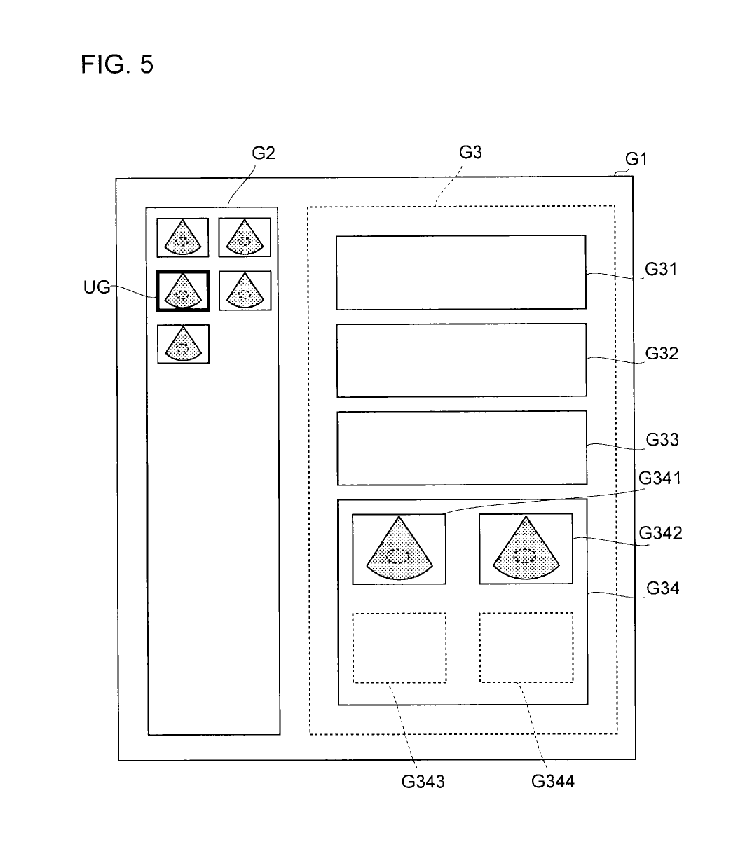

FIG. 5 illustrates an example of the medical report generation screen according to the first embodiment. A medical report generation screen G1 illustrated in FIG. 5 includes an ultrasound image display region G2 and a medical report display region G3. The medical report display region G3 further includes an inspection information region G31, a finding information region G32, a diagnosis information region G33, and an image arrangement region G34.

One or a plurality of still ultrasound images of which the user determines that it is necessary to stop through the freeze instruction unit 51 are arranged in the ultrasound image display region G2. Each of the ultrasound images is temporarily stored in the not-shown storage, and the diagnosis information, such as annotations, body marks, and measurement result, and the like, is given thereto, as needed. The diagnosis information is given by associating the ultrasound image data with the diagnosis information, or by imaging the diagnosis information superimposing on the ultrasound image. Hereinafter, “ultrasound images” arranged in the ultrasound image display region G2 and/or the image arrangement region G34 include the ultrasound images to which the diagnosis information is given, as needed, as described above.

In the inspection information region G31, Name, age, medical history, inspection content, inspection conditions, and the like, of the subject are entered and registered as the inspection information of the medical report, by the user's operation input through the operation unit 5. In the finding information region G32, the findings on the medical image are entered and registered as the finding information of the medical report, by the user's operation input through the operation unit 5. In the diagnosis information region G33, the diagnosis results based on the findings on the medical image are entered and registered as the diagnosis information of the medical report, by the user's operation input through the operation unit 5.

The ultrasound images designated by the image storage designation unit 55 from among the one or the plurality of ultrasound images displayed on the ultrasound image display region G2 can be arranged in the image arrangement region G34. For instance, an ultrasound image UG displayed on the ultrasound image display region G2 can be arranged in the image arrangement region G34 by designating the image by the image storage designation unit 55. Arrangement positions corresponding to the designation order of the ultrasound images by the image storage designation unit 55 are determined in advance by the arrangement processor 1061. The arrangement processor 1061 arranges the ultrasound image having the designation order of “1” (firstly designated) by the image storage designation unit 55 at an arrangement position G341 and the ultrasound image having the designation order of “2” (secondly designated) at an arrangement position G342. In the same manner, the arrangement processor 1061 arranges the ultrasound image having the designation order of “3” (thirdly designated) by the image storage designation unit 55 at an arrangement position G343 and the ultrasound image having the designation order of “4” (fourthly designated) at an arrangement position G344.

As described above, the report generator 1062 can arrange in the image arrangement region G34 the ultrasound images to which the measurement results by the corresponding measurement processor 105 are added. After completing the entry to the predetermined entry region in the medical report generation screen and the arrangement of the ultrasound images, and the like, at the predetermined image arrangement regions, the report generator 1062 stores the contents of the medical report generated using the medical report generation screen as medical report data in the not-shown storage or the database 4.

The arrangement processor 1061 corresponds to an example of an “arrangement processor” according to the present embodiment, and the report generator 1062 corresponds to an example of a “medical report generator” according to the embodiment.

### (Preset Storage)

The preset storage 107 is configured with a rewritable nonvolatile storage unit, and stores a various kinds of initial data for operating the medical image diagnosis apparatus 1. The medical image diagnosis apparatus 1 reads the initial data stored in the preset storage 107 out at the time of starting, and operates in accordance with the initial information. The initial information includes information for designating a kind, shape, and the like, of each region configuring the medical report generation screen illustrated in FIG. 5. Such the initial information can be changed by the user through the operation unit 5.

### (Controller)

The controller 108 controls the whole of the medical image processor 10. The controller 108 performs input determination processing for determining the contents of the user's operation input through the operation unit 5, and controls each part of the medical image processor in accordance with the determined contents of the operation input. The controller 108 is an example of “designation reception unit”.

Among the functions of the medical image processor 10 having the above described configuration, the functions of the ultrasound image acquisition unit 101, the display processor 102, the image storage processor 103, the graphic display processor 104, the measurement processor 105, the report display processor 106, and the controller 108 are implemented by a computer. Specifically, the medical image processor 10 includes, for example, a processor and a storage. The storage stores programs for implementing functions of each unit configuring the medical image processor 10. The processor implements the function of each unit of the medical image processor 10 by reading the program out from the storage to implement the processing corresponding to the program. For example, at least one of a CPU (Central Processing Unit), a GPU (Graphics Processing Unit), and an ASIC (Application Specific Integrated Circuit) is used for such the processor.

The database 4 and the medical image processor 10 correspond to an example of a “medical report generation apparatus” according to the present embodiment.

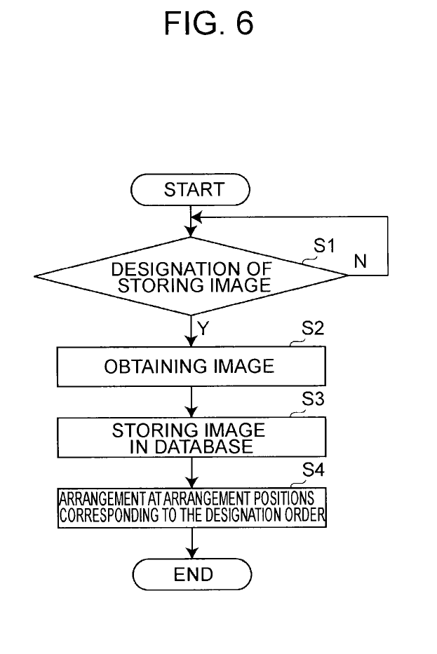

FIG. 6 illustrates a flow diagram of a processing example of arranging the ultrasound image onto the medical report by the medical image processor according to the first embodiment. Here, it is assumed a state that the medical report generation screen G1 is displayed on the display 6, and, in the ultrasound image display region G2 thereof, a plurality of still ultrasound images (including the diagnosis information thereof, as needed) the user has stopped through the freeze instruction unit 51 has been displayed.

The medical image processor 10 firstly waits until an ultrasound image to be stored is designated by the user through the image storage designation unit 55 (step S1: N). Specifically, the controller 108 waits until any of the plurality of ultrasound images in the ultrasound image display region G2 is designated by the user through the image storage designation unit 55.

When an ultrasound image is designated through the image storage designation unit 55 (step S1: Y), the medical image processor 10 obtains the designated ultrasound image (step S2). Specifically, when the controller 108 causes the image storage designation unit 55 to designate an ultrasound image in the ultrasound image display region G2, the image storage processor 103 obtains the ultrasound image as well as the image including shapes (graphics), such as annotations, body marks, and the like, and the measurement result displayed superimposing thereon.

The medical image processor 10 then stores the ultrasound image, and the like, obtained in the step S2 in the database 4, and outputs those images to the report display processor 106 (step S3). Specifically, the image storage processor 103 stores the ultrasound image as well as the image including the shapes, such as annotations, body, marks, and the like, and the measurement result superimposed and displayed thereon obtained in the step S2 in the database 4, and outputs those images to the report display processor 106.

Next, the medical image processor 10 arranges the ultrasound image, and the like, stored in the database 4 in the step S3 at arrangement positions in an image arrangement region of a medical report corresponding to the designation order by the image storage designation unit 55 in the step S1 (step S4). Specifically, the report generator 1062 generates a medical report by arranging the ultrasound image and the associated annotations, and the like, in the image arrangement region of the medical report in the order of the ultrasound image designated by the image storage designation unit 55. The medical report processor 10 then terminates a series of the processing (end).

### Operation Example

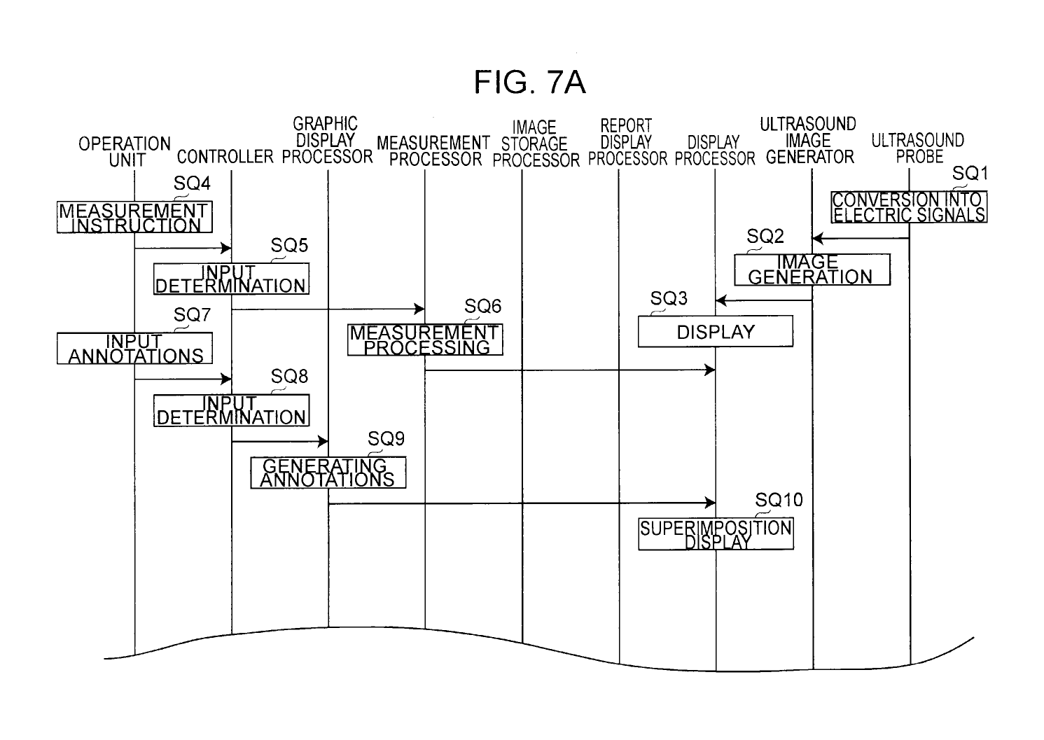

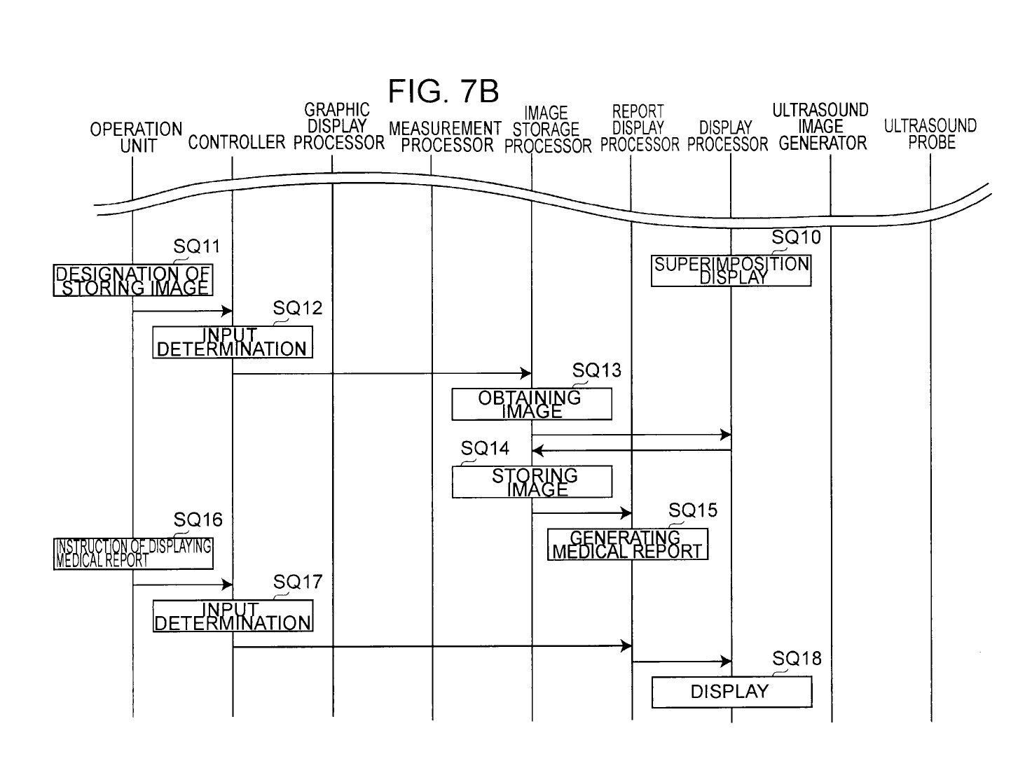

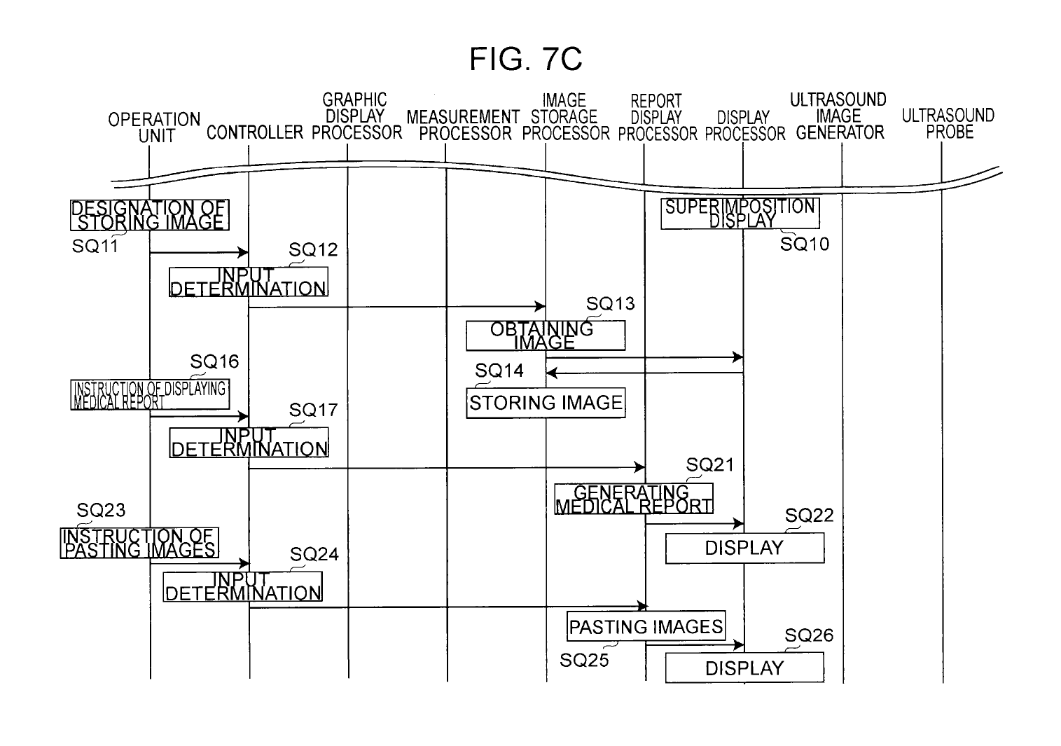

FIGS. 7A and 7B illustrate sequence diagrams of operation examples of the medical image diagnosis apparatus 1 according to the first embodiment. FIGS. 7A and 7B represent a process flow of each block configuring the medical image diagnosis apparatus 1 in the vertical direction orthogonal to arrows, and a flow of information between the blocks in the arrow direction. It is assumed that the same parts are donated by the same signs in FIGS. 7A and 7B, and the operation illustrated in FIG. 7A is performed followed by the operation illustrated in FIG. 7B. In FIGS. 7A and 7B, an illustration of the ultrasound image acquisition unit is omitted.

The ultrasound probe 2 shifted from the stopped state to the ultrasound scanable state converts the reflected waves from the subject into electric signals, and receives the signals as echo signals (SQ1). The echo signals received by the ultrasound probe 2 are output to the ultrasound image generator 3.

The ultrasound image generator 3 generates an ultrasound image based on the echo signals received by the ultrasound probe 2 (SQ2). Image data of the ultrasound image generated by the ultrasound image generator 3 is acquired by the ultrasound image acquisition unit 101, and the ultrasound image acquisition unit 101 outputs the acquired image data to the display processor 102.

The display processor 102 causes the display 6 to display the ultrasound image acquired by the ultrasound image acquisition unit 101 (SQ3). At this time, the ultrasound image may be a still ultrasound image the user has stopped through the freeze instruction unit 51, or may be an image displayed on the display 6 in real time.

The user who looked at the ultrasound image displayed on the display 6 instructs the start of measuring through the measurement instruction unit 52. Once the measurement start is instructed from the measurement instruction unit 52, the controller 108 receives the operation information corresponding to the operation content from the measurement instruction unit 52, performs the input determination processing based on the operation information (SQ5), and determines that the instruction of the measurement start is received from the user. The controller 108 then outputs a control signal for instructing the measurement start to the measurement processor 105.

The measurement processor 105 received the control signal for instructing the measurement start from the controller 108 performs measurement processing of the content set by the user in advance (SQ6). The result of the measurement processing performed by the measurement processor 105 is output to the display processor 102.

Further, the user who looked at the ultrasound image displayed on the display 6 also inputs or specifies annotations by the annotation input unit 53. Once input or specification of annotations by the annotation input unit 53 is designated (SQ7), the controller 108 receives the operation information corresponding to the operation content from the annotation input unit 53, performs the input determination processing based on the operation information (SQ8), and determines that the designation of input or specification of annotations is received from the user. The controller 108 then outputs a control signal for outputting pattern data of the input or specified annotations to the graphic display processor 104.

The graphic display processor 104 which received the control signal for outputting the pattern data of the annotations from the controller 108 generates, based on the control signal, the graphic data corresponding to the text input by the user as the pattern data, reads the pattern data corresponding to the annotations specified by the user out from a graphic memory (SQ9). The pattern data generated or read out by graphic display processor 104 is output to the display processor 102.

The display processor 102 which received the measurement result from the measurement processor 105 and the pattern data from the graphic display processor 104 superimposes the measurement result and the annotations corresponding to the pattern data on the ultrasound image, and causes the display 6 to display the resultant image (SQ10). The ultrasound image (including the measurement result and the annotations) which has been superimposed and displayed on the display 6 in SQ10 is displayed in the ultrasound image display region G2 of the medical report generation screen.

Here, it is assumed that the user designates that a desired ultrasound image (including the measurement result and the annotations) from among the one or the plurality of ultrasound images displayed in the ultrasound image display region G2 of the medical report generation screen is stored in the database 4 by the image storage designation unit 55 and arranged onto the medical report. Once the desired ultrasound image is designated by the image storage designation unit 55 (SQ11), the controller 108 receives the operation information corresponding to the operation content from the image storage designation unit 55, performs the input determination processing based on the operation information (SQ12), and determines that image storage is designated by the user. The controller 108 then outputs a control signal for storing the designated ultrasound image to the image storage processor 103.

The image storage processor 103 which received the control signal for storing the ultrasound image from the controller 108 performs on the display processor 102, based on the control signal, acquisition request of image data of the desired ultrasound image from among the plurality of ultrasound images displayed in the ultrasound image display region G2 on the display 6, and acquires the image data of the desired ultrasound image (SQ13). In the case of FIG. 7B, the superimposed and displayed image includes the ultrasound image, the measurement result, and the annotations. The image storage processor 103 stores the image (image data) acquired in SQ13 in the database 4 (SQ14). Further, the image storage processor 103 outputs the acquired image (image data) or link information thereof to the report display processor 106.

The report display processor 106 generates a medical report by arranging the image acquired in SQ13 at an arrangement position in the image arrangement region of the medical report (SQ15). Here, the image acquired in SQ13 is arranged at the arrangement position in the image arrangement region corresponding to the designation order of the image storage designation unit 55. When the image (image data) is received from the image storage processor 103, the report display processor 106 performs the arrangement of the image in a state that, for example, the image (image data) is associated with the arrangement position by storing the image in a storage region corresponding to the arrangement position. When the link information of the image is received form the image storage processor 103, the report display processor 106 performs the arrangement of the image by linking the image with the arrangement position based on the link information. As a result, in SQ15, medical report data including the data in each region displayed in the medical report display region G3 in FIG. 5 is generated.

Next, it is assumed that the user instructs through the report display instruction unit 56 for causing the display 6 to display the medical report generated in SQ 15. When display of the medical report is instructed through the report display instruction unit 56 (SQ16), the controller 108 receives the operation information corresponding to the operation content from the report display instruction unit 56, performs the input determination processing based on the operation information (SQ17), and determines that display of the medical report is instructed from the user. The controller 108 then outputs a control signal for displaying the medical report to the report display processor 106.

The report display processor 106 which received the control signal for displaying the medical report form the controller 108 outputs the medical report data generated in SQ15 to the display processor 102, and the display processor 102 causes the display 6 to display the medical report (SQ18).

Although it has been described the case that the user performs the input instruction of the annotations in FIGS. 7A and 7B, the case that the user performs the input instruction of body marks is also done in the same manner.

As described above, the medical image diagnosis apparatus 1 according to the first embodiment generates a medical report by arranging the designated ultrasound images in order at arrangement positions in the image arrangement region corresponding to the storage order designated by the user through the image storage designation unit 55. Thereby, the user is released from the work of manually pasting ultrasound images, and it is possible to shorten inspection time because of simplifying the pasting work of the ultrasound images onto a medical report.

For instance, when acquisition of ultrasound images and generation of a medical report are done by the same user, the user often remembers the timings at which the ultrasound images stopped. Pasting of the ultrasound images in the designated order onto the medical report, therefore, can contribute to significant simplification of the work.

### First Modified Example of the First Embodiment

In the first embodiment, it has been described the case that a medical report is generated by storing ultrasound images and designating of arrangement onto the medical report through the image storage designation unit 55, however, the first embodiment is not limited thereto. In a first modified example of the first embodiment, after the medical report is displayed, upon reception of an instruction from a paste instruction unit, a new medical report is generated by pasting the images onto the displayed medical report. Hereinafter, it is described mainly the differences between the first embodiment and the first modified example thereof.

In the first modified example of the first embodiment, the image storage designation unit 55 is used for designating storage of a desired ultrasound image. The arrangement processor 1061 determines an arrangement position in an image arrangement region provided in a medical report for the ultrasound image designated by the user through the image storage designation unit 55. In addition, the operation unit 5 further includes a paste instruction unit which receives a paste instruction of the desired ultrasound image. The report generator 1062, upon reception of the paste instruction from the paste instruction unit, generates a medical report by arranging the desired medical image at the arrangement position determined by the arrangement processor 1061.

FIG. 7C illustrates a sequence diagram of a part of an operation example of the medical image diagnosis apparatus 1 according to the first modified example of the first embodiment. FIG. 7C represent a process flow of each block configuring the medical image diagnosis apparatus 1 in the vertical direction orthogonal to arrows, and a flow of information between the blocks in the arrow direction. The operation illustrated in FIG. 7A is performed followed by the operation illustrated in FIG. 7C. In FIG. 7C, the parts same as that of in FIG. 7B are donated by the same signs, and the explanations thereof are appropriately omitted. Also in FIG. 7C, an illustration of the ultrasound image acquisition unit is omitted.

The sequences from SQ1 to SQ12 are the same as in FIGS. 7A and 7B.

After SQ12, the image storage processor 103 which received the control signal for storing the ultrasound image from the controller 108 performs on the display processor 102, based on the control signal, acquisition request of image data of the desired ultrasound image from among the plurality of ultrasound images displayed in the ultrasound image display region G2 of the display 6, and acquires the image data of the desired ultrasound image (SQ13). In the case of FIG. 7C, the superimposed and displayed image includes the ultrasound image, the measurement result, and the annotations. The image storage processor 103 stores the image (image data) acquired in SQ13 in the database 4 (SQ14).

Here, it is assumed that the user instructs through the report display instruction unit 56 for causing the display 6 to display a medical report. When display of the medical report is instructed through the report display instruction unit 56 (SQ16), the controller 108 receives the operation information corresponding to the operation content from the report display instruction unit 56, performs the input determination processing based on the operation information (SQ17), and determines that display of a medical report is instructed from the user. The controller 108 then outputs the control signal for displaying the medical report to the report display processor 106.

The report display processor 106 generates a medical report by arranging data, such as finding data other than the ultrasound image acquired in SQ13, and the like, in a predetermined region of the medical report (SQ21). The medical report generated in SQ21 is, for example, a medical report in a predetermined format, to which the finding data, and the like, are arranged, however, the image acquired in SQ13 is not arranged therein.

The controller 108 then outputs the control signal for displaying the medical report to the report display processor 106. The report display processor 106 which received the control signal for displaying the medical report from the controller 108 outputs the medical report data generated in SQ15 to the display processor 102, and the display processor 102 causes the display 6 to display the medical report (SQ22).

Here, it is assumed that the user instructs pasting of the ultrasound images onto the medical report displayed on the display 6 through the paste instruction unit. Once the pasting of the ultrasound images is instructed though the paste instruction unit (SQ23), the controller 108 receives the operation information corresponding to the operation content from the paste instruction unit, performs the input determination processing based on the operation information (SQ24), and determines that the pasting of the ultrasound images is instructed from the user. The controller 108 then outputs the control signal for pasting the ultrasound images onto the medical report to the report display processor 106.

The report display processor 106 arranges the image acquired in SQ13 at an arrangement position in an image arrangement region of the medical report (that is, generates the medical report) (SQ25). Here, the image acquired in SQ13 is arranged at the arrangement position in the image arrangement region corresponding to the order designated by the image storage designation unit 55 in the same manner as in the first embodiment, however, the image may be arranged at an arrangement position in an image arrangement region determined in the embodiments described below or modified examples thereof. When the image (image data) is received from the image storage processor 103, the report display processor 106 performs, for example, the arrangement of the image in a state that the arrangement position is associated with the image, by storing the image (image data) in a storage region corresponding to the arrangement position. When the link information of the image is received form the image storage processor 103, the report display processor 106 performs the arrangement of the image by liking the image with the arrangement position based on the link information. As the result, in SQ25, medical report data including the data in each region displayed in the medical report display region G3 is generated.

The controller 108 then outputs the control signal for displaying the medical report to the report display processor 106. The report display processor 106 which received the control signal for displaying the medical report from the controller 108 outputs the medical report data to which the ultrasound image is pasted in SQ25 to the display processor 102, and causes the display 6 to display the medical report (SQ26).

As described above, in the first modified example of the first embodiment, the paste instruction unit which receives the paste instruction of a desired ultrasound image is provided. Thus, it can be applicable even when the user wishes to store an ultrasound image but not to paste the images onto a medical report. It is also possible to simplify the pasting work of ultrasound images onto a medical report, when the user wishes to paste any desired ultrasound images onto the medical report after storing the ultrasound images.

### Second Modified Example of the First Embodiment

In the first embodiment, it has been described the case that storage of ultrasound images and designation of arrangement onto a medical report are performed through the image storage designation unit 55, however, the first embodiment is not limited thereto. In a second modified example of the first embodiment, instead of the image storage designation unit 55 as the designation unit, a first designation unit for designating storage of ultrasound images and a second designation unit for designating storage and arrangement of ultrasound images are provided.

The medical image diagnosis apparatus 1 according to the second modified example of the first embodiment differs from the medical image diagnosis apparatus 1 according to the first embodiment in mainly the operation unit and the controller of the medical image processor for determining the operation content of the operation unit. Hereinafter, the differences are mainly described.

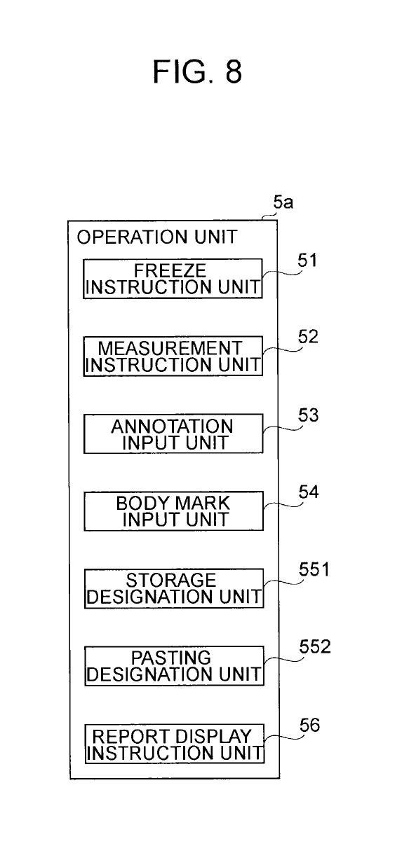

FIG. 8 illustrates a configuration example of the operation unit which is represented in function blocks according to the second modified example of the first embodiment. In FIG. 8, the same parts as in FIG. 2 are donated by the same signs, and the descriptions are appropriately omitted. In the medical image diagnosis apparatus 1 illustrated in FIG. 1, an operation unit 5a illustrated in FIG. 8 is provided, instead of the operation unit 5.

The operation unit 5a includes the freeze instruction unit 51, the measurement instruction unit 52, the annotation input unit 53, the body mark input unit 54, a storage designation unit 551, a pasting designation unit 552, and the report display instruction unit 56. Each of the storage designation unit 551 and the pasting designation unit 552 is configured by any of pointing device, operation switches, operation buttons, operation knobs, or a keyboard.

Each of the storage designation unit 551 and the pasting designation unit 552 is used for the user to designate ultrasound images to be stored in the database 4 each one at a time from the ultrasound images generated based on the echo signals received by the ultrasound probe 2. The ultrasound images designated by each of the storage designation unit 551 and the pasting designation unit 552 are stored with the associated diagnosis information, such as annotations, body marks, and the like, in the database 4. Further, the ultrasound images designated by the pasting designation unit 552 are arranged at arrangement positions in the image arrangement region set in a medical report, along with the associated diagnosis information, such as annotations, body marks, and the like.

The controller of the medical processor configuring the medical image diagnosis apparatus according to the second modified example of the first embodiment receives operation information of the storage designation unit 551, and controls the image storage processor based on the operation information. The controller also receives operation information of the pasting designation unit 552, and controls the image storage processor and the report display processor based on the operation information, in the same manner as in the first embodiment. Specifically, when designation of a desired ultrasound image from the storage designation unit 551 is received by the controller, the controller controls the image storage processor to store the desired ultrasound image in the database 4.

On the other hand, when designation of the desired ultrasound image from the pasting designation unit 552 is received by the controller, the report display processor (report generator) generates a medical report by arranging the desired ultrasound image designated by the pasting designation unit 552 in the image arrangement region, and controls the image storage processor to store the desired ultrasound image in the database 4.

For instance, in a health examination for purpose of both detecting abnormality and confirming normality in a test region, it can be assumed that storage of ultrasound images is necessary, while pasting of the images onto a medical report is not necessary, in many cases. According to the second modified example of the first embodiment, the first designation unit for designating storage in the database and the second designation unit for designating storage in the database as well as pasting onto a medical report are provided, therefore, it can contribute to work efficiency of the user by selectively utilizing those two kinds of the designation parts by the user.

### Second Embodiment

In the first embodiment or the modified examples thereof, it has been described that ultrasound images are arranged in a medical report in designated storage order, however, in a second embodiment, ultrasound images corresponding to a predetermined condition are arranged onto a medical report, among from designated ultrasound images.

The medical image diagnosis apparatus according to the second embodiment differs from the medical image diagnosis apparatus 1 according to the first embodiment in mainly the image storage processor and the report display processor. Hereinafter, the differences are mainly described.

The image storage processor according to the second embodiment performs processing on the ultrasound image designated by the image storage designation unit 55 to store in the database 4. The report display processor according to the second embodiment generates a medical report by arranging an ultrasound image onto the medical report which matches a condition set in advance, from among the ultrasound images the image storage processor stores in the database.

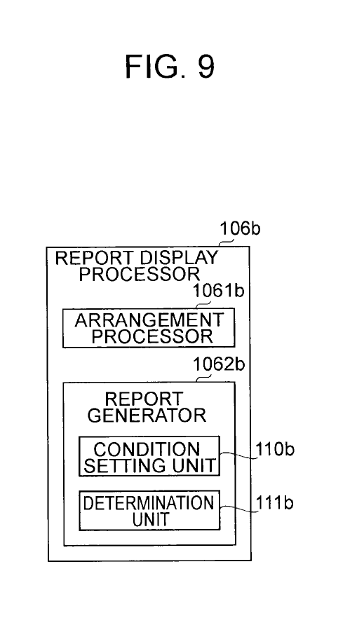

FIG. 9 illustrates a block diagram of a configuration example of the report display processor according to the second embodiment. In the medical image diagnosis apparatus 1 illustrated in FIG. 1, instead of the report display processor 106, a report display processor 106b illustrated in FIG. 9 is provided.

The report display processor 106b includes the arrangement processor 1061 and a report generator 1062b. The report generator 1062b includes a condition setting unit 110b and a determination unit 111b. The determination unit 111b corresponds to an example of the determination unit.

In the condition setting unit 110b, a condition for arranging an ultrasound image designated by the image storage designation unit 55 in the image arrangement region of a medical report is set in advance. This condition is, for example, that an ultrasound image includes an object registered in advance. Here, the object is image information given to a medical image. The image information can include at least one of body marks, annotations, and measurement labels. The user can add, delete or change the condition for arranging an ultrasound image in the image arrangement region of a medical report with respect to the condition setting unit 110b through the operation unit 5.

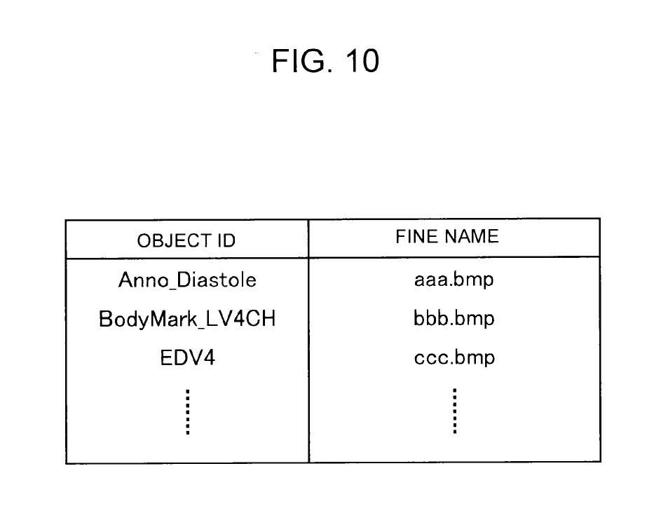

FIG. 10 illustrates an example of the condition set by the condition setting unit 110b of the second embodiment. In the condition setting unit 110b, for example, image data (bitmapped image data in FIG. 10) of an object corresponding to an object identifier (ID) for identifying a search object is set in advance. For instance, an object ID of “Anno Diastole” is allocated to an annotation indicating diastole of the ventricle, and the file name of the image data of the object is “aaa.bmp”. Therefore, when the annotation indicating diastole of the ventricle is added to an ultrasound image, the image data of the file named “aaa.bmp” is included in the ultrasound image. For that reason, by detecting whether or not the image data of an ultrasound image includes the image data of the file named “aaa.bmp”, it is possible to detect whether or not the annotation indicating diastole of the ventricle is added to the ultrasound image. In addition, for example, an object ID of “BodyMark_LV4CH” is allocated to the body mark indicating a cross-section of the left ventricle, and the file name of the image data of the object is “bbb.bmp”. Therefore, when the body mark indicating the cross-section of the left ventricle is added to an ultrasound image, the image data of the file named “bbb.bmp” is included in the ultrasound image. For that reason, by detecting whether or not the image data of an ultrasound image includes the image data of the file named “bbb.bmp”, it is possible to detect whether or not the body mark indicating the cross-section of the left ventricle is added to the ultrasound image.

The determination unit 111b performs the following determination processing on the desired ultrasound image designated through the image storage designation unit 55, the desired ultrasound image designated through the image storage designation unit 55 on which the above object is added, or the desired ultrasound image designated through the image storage designation unit 55 on which the above object is superimposed. Hereinafter, the desired ultrasound image designated through the image storage designation unit 55, the desired ultrasound image designated through the image storage designation unit 55 on which the above object is added, or the desired ultrasound image designated through the image storage designation unit 55 on which the above object is superimposed is appropriately called as a determination subject image.

When designation of the desired ultrasound image through the image storage designation unit 55 is received by the controller, the determination unit 111b determines whether or not the determination subject image matches the condition set in advance by the condition setting unit 110b. When the determination unit 111b determines that the determination subject image matches the condition set in advance by the condition setting unit 110b, the report display processor 106b arranges the determination subject image in the image arrangement region of the medical report.

Specifically, the determination subject image is stored in the database 4. The determination unit 111b then retrieves the determination subject image stored in the database 4, and determines whether or not the image data of the object specified by the file name illustrated in FIG. 10 is included therein, for example, using any publically known pattern matching technique. When the object is arranged at a predetermined coordinate position in the determination subject image, the determination unit 111b can determine whether or not the object illustrated in FIG. 10 is included in the image specified by the coordinate position.

The configuration of the medical image diagnosis apparatus according to the second embodiment is almost identical to the configuration of the medical image diagnosis apparatus according to the first embodiment, except the above mentioned matters. Therefore, hereinafter, the configuration of the second embodiment is described appropriately using the signs in FIG. 1 for convenience of explanation.

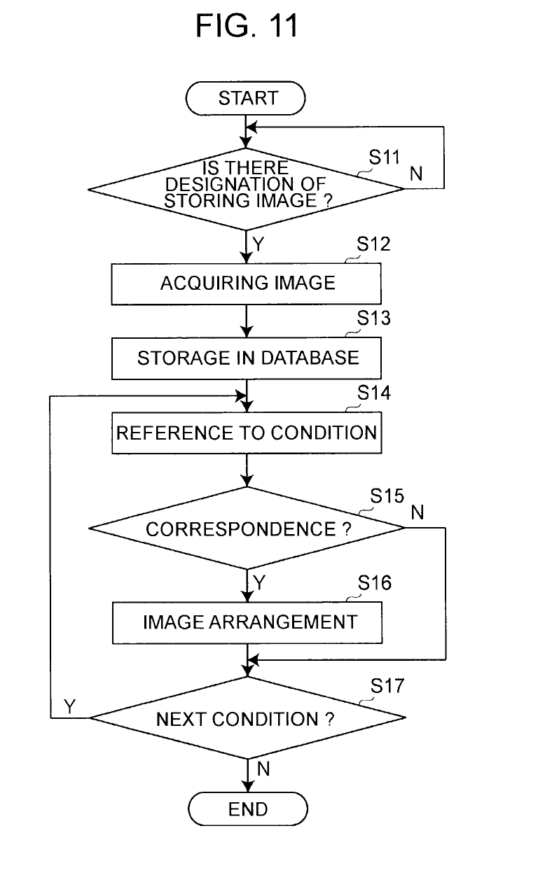

FIG. 11 illustrates a flow diagram of an arrangement processing example of an ultrasound image onto a medical report through the medical image processor according to the second embodiment. Here, similar to FIG. 6, it is assumed that the medical report generation screen is displayed on the display 6, and within the ultrasound image display region thereof, a plurality of still ultrasound images (including diagnosis information thereof, as needed) the user has stopped through the freeze instruction unit has been already displayed.

Firstly, the medical image processor waits until an ultrasound image of the storage subject is designated by the user through the image storage designation unit 55 (step S11: N). When the ultrasound image is designated through the image storage designation unit 55 (step S11: Y), the medical image processor acquires the designated ultrasound image as well as an image including the shapes, such as annotations, body marks, and the like, and the measurement result, which are superimposed and displayed on the ultrasound image (step S12).

The medical image processor then stores the ultrasound image, and the like, acquired in the step S12 in the database 4 (step S13). Specifically, the image storage designation unit 55 stores the ultrasound image acquired in the step S12 as well as the image including shapes, such as annotations, body marks, and the like, and the measurement result, which are superimposed and displayed on the ultrasound image, in the database 4.

Next, the medical image processor refers to the first condition from among the one or the plurality of conditions set in advance for the ultrasound image stored in the database 4 in the step S13 (step S14). Specifically, in the report generator 1062b, the determination unit 111b refers to the first condition from among the one or the plurality of the conditions set in advance by the condition setting unit 110b.

The medical image processor 10 then determines whether or not the ultrasound image stored in the database 4 in the step S13 matches the condition of reference in the step S14 (step S15). Specifically, the determination unit 111b retrieves the above mentioned determination subject image, and determines whether or not the objects set in advance by the condition setting unit 110b exist in the image.

When it is determined that the objects set in advance exist in the determination subject image, it is determined that the image matches the condition set in advance (step S15: Y), and the medical image processor arranges the determination subject image at an arrangement position in the image arrangement region of a medical report (step S16). Specifically, the medical image processor arranges the determination subject image at an arrangement position in the image arrangement region of the medical report corresponding to the order the image matches the condition in the step S15. For instance, the determination subject image firstly matches the condition is arranged in the arrangement position G341 in the image arrangement region G34 illustrated in FIG. 5, and the determination subject image secondly matches the condition is arranged in the arrangement position G342 in the image arrangement region G34 illustrated in FIG. 5. In the same manner, the determination subject image thirdly matches the condition is arranged in the arrangement position G343 in the image arrangement region G34 illustrated in FIG. 5, and the determination subject image fourthly matches the condition is arranged in the arrangement position G344 in the image arrangement region G34 illustrated in FIG. 5.

When it is determined that there is no preset object in the determination subject image (step S15: N), or subsequently to the step S16, the medical image processor determines whether or not the next condition is set by the condition setting unit 110b (step S17). When it is determined that there is the next condition (step S17: Y), the medical image processor proceeds to the step S14, and continues processing concerning the next condition. When it is determined that there is no next condition in the step S17 (step S17: N), the medical image processor terminates a series of the processing (end).

In this way, each of the ultrasound images (determination subject images) designated by the image storage designation unit 55 is arranged at the arrangement position in the image arrangement region of the medical report in order on the condition that the image matches at least one of the preset conditions. The determination subject images which do not match any of the conditions are not arranged in the medical report so that it is possible to provide a medical image diagnosis apparatus which can designate out from the pasting subjects onto the medical report from among the determination subject images stored in the database 4.

In the second embodiment, it has been described that the determination unit 111b retrieves the determination subject image for determining whether or not any preset objects exist in the image, however, the determination unit 111b is not limited thereto. For example, based on the information (accessory information) given when the objects, such as annotations, body marks, and the like, are input in the ultrasound image, the determination unit 111b may determine whether or not any desired objects exits in the determination subject image.

As described above, the medical image diagnosis apparatus according to the second embodiment generates a medical report by arranging ultrasound images (determination subject images) designated by the user through the image storage designation unit 55 at the arrangement positions in the image arrangement region of the medical report in order on the condition that the images match the preset conditions. That is, pasting onto the medical report can be realized based on the characters or the accessory information within the ultrasound images. The user, therefore, is released from the work of manually pasting ultrasound images, and shortening inspection time can be realized by simplifying the pasting work of the ultrasound images onto a medical report.

For instance, in a case that the inspection order is predetermined in a large-scale medical institution, and the like, it is possible for a doctor who interprets, or the like, to progress with the pasting work of ultrasound images without spending a lot of time on it to efficiently generate a medical report.

### Third Embodiment

In the first embodiment, the modified examples thereof, or the second embodiment, it has been described that ultrasound images are arranged in arrangement positions corresponding to the designated order of the ultrasound images, or the order which matches a condition set in advance. Whereas, in a third embodiment, at an arrangement position in the image arrangement region corresponding to a condition set in advance, an ultrasound image which matches the condition is arranged.

The medical image diagnosis apparatus according to the third embodiment differs from the medical image diagnosis apparatus according to the second embodiment is mainly processing contents of the report display processor. Hereinafter, the difference is mainly described.

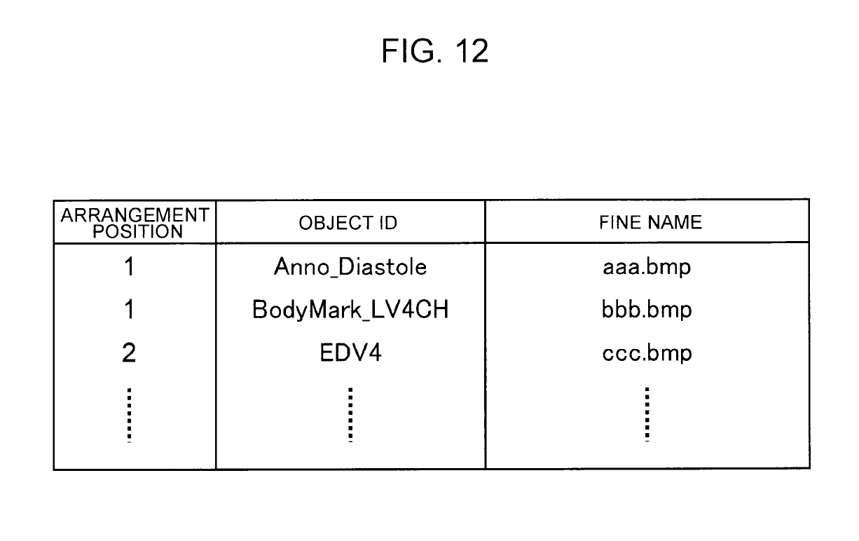

FIG. 12 illustrates an example of conditions set by the setting unit in the third embodiment. In the condition setting unit according to the third embodiment, for example, arrangement positions in the image arrangement region of a medical report, object IDs for identifying retrieve subject objects, image data thereof are set in advance. For instance, the file name of the data image with the object ID “Anno Diastole” is “aaa.bmp”, and the arrangement position thereof is “1”. Also, for instance, the file name of the data image with the object ID “BodyMark_LV4CH” is “bbb.bmp”, and the arrangement position thereof is “2”.

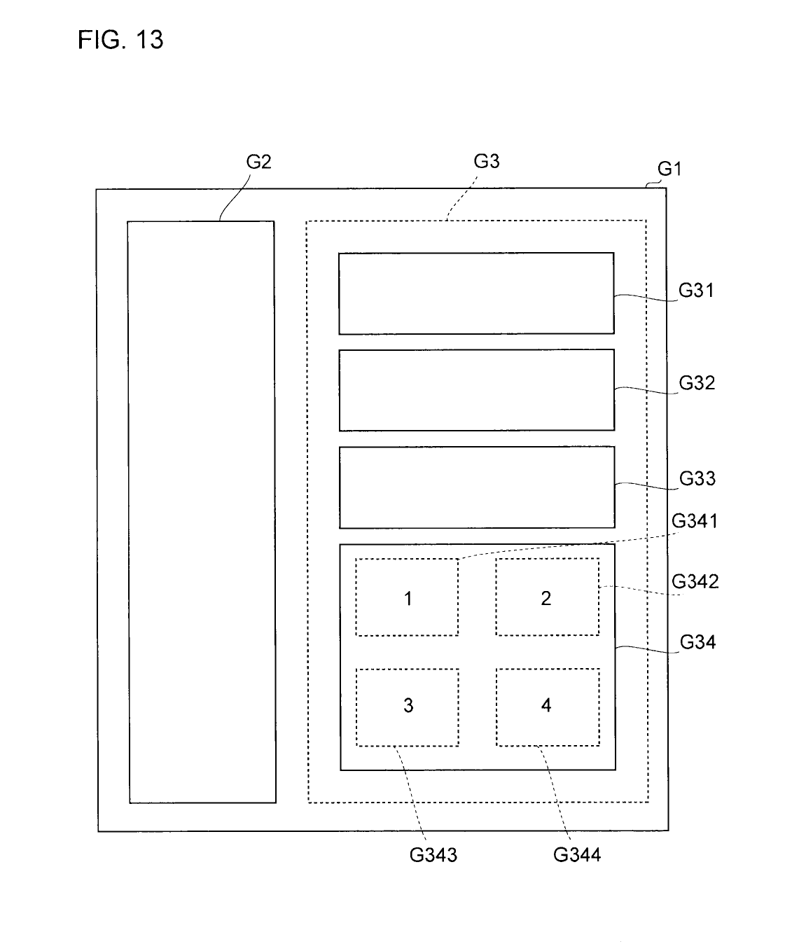

FIG. 13 schematically illustrates the medical report display region of the medical report generation screen in the third embodiment. In FIG. 3, the same parts as in FIG. 5 are donated by the same signs, and the explanations thereof are appropriately omitted.

The image arrangement region G34 are provided with the arrangement positions G341 to G344, in the same manner as in the first embodiment. In the third embodiment, layout positions “1” to “4” are respectively allocated to each of the arrangement positions G341 to G344.

The determination unit according to the third embodiment determines, in the same manner as in the second embodiment, whether or not the determination subject image matches the condition set in advance by the condition setting unit. When it is determined that the determination subject image matches the condition set in advance by the condition setting unit, the report display processor arranges the determination subject image at the arrangement position in the image arrangement region of the medical report corresponding to the condition. Specifically, the arrangement processor provided to the report generator refers to the arrangement position corresponding to the condition set by the condition setting unit upon reception of the determination result from the determination unit, and determines the arrangement position of the ultrasound image determined to match the condition. For instance, when the determination unit determines that there is the same object as “aaa.bmp” in the ultrasound image designated by the image storage designation unit 55, the arrangement processor refers to the arrangement position corresponding to the condition set by the condition setting unit upon reception of the determination result from the determination unit, and determines the arrangement position of the ultrasound image as the arrangement position G341 with the layout poison of “1” in the image arrangement region in the medical report. Also, when the determination unit determines that there is the same object as “bbb.bmp” in the ultrasound image designated by the image storage designation unit 55, the arrangement processor refers to the arrangement position corresponding to the condition set by the condition setting unit upon reception of the determination result from the determination unit, and determines the arrangement position of the ultrasound image as the arrangement position G342 with the layout poison of “2” in the image arrangement region of in medical report. The report generator then arranges the ultrasound image at the arrangement position determined by the arrangement processor to generate the medical report.

The configuration of the medical image diagnosis apparatus according to the third embodiment is almost identical to the configuration of the medical image diagnosis apparatus according to the second embodiment except the above mentioned matters. Therefore, hereinafter, the configuration of the third embodiment is described using the signs in FIG. 1 for convenience of explanation.

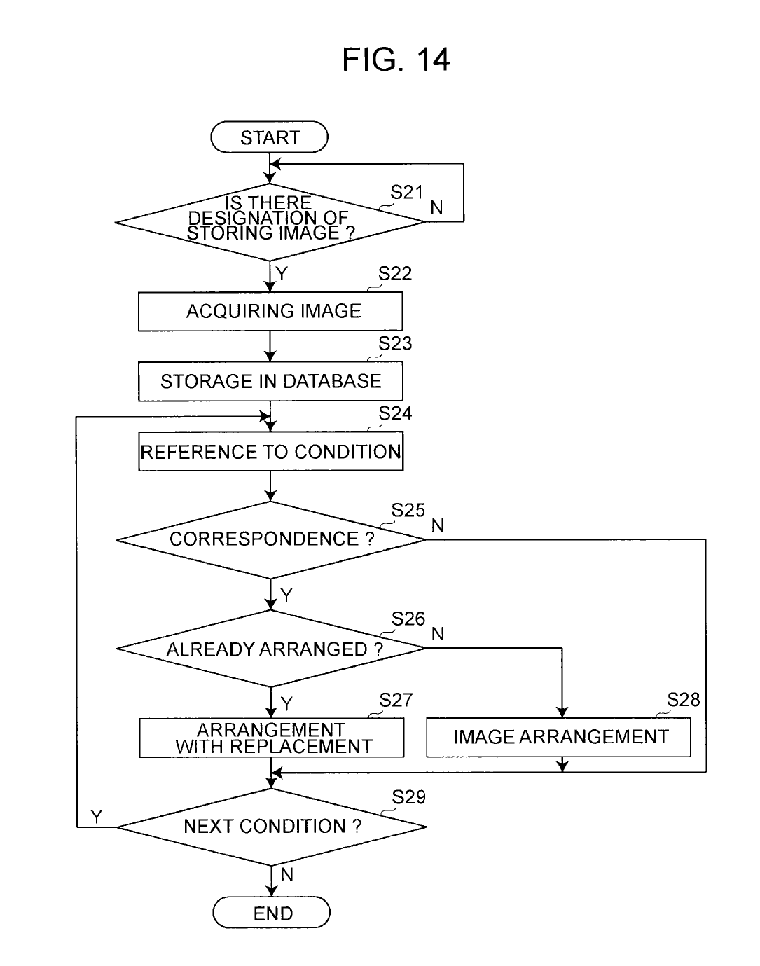

FIG. 14 illustrates a flow diagram of a processing example of arranging an ultrasound image onto a medical report by the medical image processor according to third embodiment. Here, it is assumed that the medical report generation screen is displayed on the display 6, and a plurality of still ultrasound images (including the diagnosis information, as needed) the user has stopped through the freeze instruction unit has been displayed in the ultrasound image display region thereof.

The medical image processor firstly waits until an ultrasound image for storage is designated by the user through the image storage designation unit 55 (step S21: N). When the ultrasound image is designated by the image storage designation unit 55 (step S21: Y), the medical image processor acquires the designated ultrasound image as well as an image including shapes, such as annotations, body marks, and the like, and the measurement result, which are superimposed and displayed on the ultrasound image (step S22).

The medical image processor then stores the ultrasound image, and the like, acquired in the step S22 in the database 4 (step S23). Next, the medical image processor refers to the first condition from among the one or the plurality of conditions set in advance for the ultrasound images stored in the database 4 in the step S23 (step S24).

The medical image processor 10 then determines whether the ultrasound images stored in the database 4 in the step S23 matches the condition of reference in the step S24 (step S25).

The medical image processor subsequently determines whether or not other ultrasound image has already been arranged at the arrangement position corresponding to the condition matched in the step S25 (step S26). The step S26 is, for example, performed by the report generator of the layout display processor.

When it is determined that other ultrasound image has already been arranged (step S26: Y), the report generator arranges a new ultrasound image determined to match the condition in the step S25 replacing with the other ultrasound image (step S27). On the other hand, when it is not determined that other ultrasound image has already been arranged (step S26: N), the report generator arranges a new ultrasound image determined to match the condition in the step S25 at the arrangement position corresponding to the condition (step S28).

When it is determined that the image does not match the condition (step S25: N), subsequently to the step S27 or the step S28, the medical image processor determines whether or not a next condition is set by the condition setting unit (step S29). When it is determined that a next condition is set (step S29: Y), the medical image processor transfers to the step S24, and continues processing concerning the next condition. When it is determined that there is no next condition in the step S29 (step S29: N), the medical image processor terminates a series of the processing (end).

In this way, when the ultrasound image designated by the image storage designation unit 55 matches the condition set in advance, the image is arranged at the arrangement position in the image arrangement region of the medical report corresponding to the condition. At this time, in the case that other ultrasound image has already been arranged at the arrangement position for a new ultrasound image, when the designation of the new ultrasound image through the image storage designation unit 55 is received by the controller, the report generator arranges the new ultrasound image replacing with the other ultrasound image.

As described above, when the ultrasound image designated by the user through the image storage designation unit 55 matches the condition set in advance, the medical image diagnosis apparatus according to the third embodiment generates a medical report by arranging the image at the arrangement position corresponding to the above condition in the image arrangement region in the medical report. Therefore, in the third embodiment, although the image is pasted onto a medical report regardless of the storage order, the pasting work of the ultrasound image onto the medical report can be simplified, when the image type of the ultrasound image is set in advance for every arrangement position.

### First Modified Example of the Third Embodiment

In the third embodiment, when other ultrasound image has already been arranged at an arrangement position for an ultrasound image which matches a condition, it has been described to replace each other to rearrange, however, the third embodiment dose not limited thereto. In a first modified example of the third embodiment, when other ultrasound image has already been arranged at an arrangement position for an ultrasound image which matches a condition, the situation is notified to the user.

The medical image diagnosis apparatus according to the first modified example of the third embodiment differs from the medical image diagnosis apparatus according to the third embodiment in mainly process contents of the report display processor. Hereinafter, the difference is mainly described.

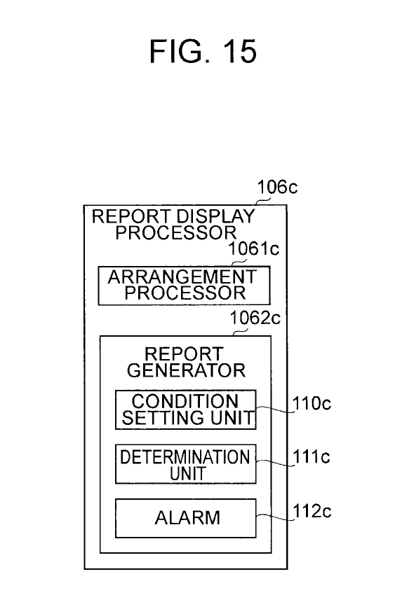

FIG. 15 illustrates a block diagram of a configuration example of the report display processor according to the first modified example of the third embodiment. In the medical image diagnosis apparatus 1 illustrated in FIG. 1, instead of the report display processor 106, a report display processor 106c illustrated in FIG. 15 is provided. In FIG. 15, the same parts as in FIG. 9 are donated by the same signs, and the explanations thereof are appropriately omitted.

In the report display processor 106c includes an arrangement processor 1061c and a report generator 1062c. The report generator 1062c includes a condition setting unit 110c, a determination unit 111c, and an alarm 112c. The alarm 112c corresponds to an example of an “alarm” according to the present embodiment.

In the condition setting unit 110c, conditions for arranging the ultrasound images designated by the image storage designation unit 55 in the image arrangement region in the medical report are set in advance. Further, the user can add, delete or change the conditions for arranging the ultrasound images in the image arrangement region in the medical report for the condition setting unit 110b through the operation unit 5. When designation of the desired ultrasound image through the image storage designation unit 55 is received by the controller, the determination unit 111c determines whether or not the ultrasound image designated through the image storage designation unit 55 matches the condition set in advance by the condition setting unit 110c.

When the determination unit 111c determines that the ultrasound image designated through the image storage designation unit 55 matches the condition set in advance by the condition setting unit 110c, the report display processor 106c arranges the ultrasound image at the arrangement position designated in the image arrangement region of the medical report.

When other ultrasound image has already been arranged at the arrangement position for a new ultrasound image that the determination unit 111c determined to match the condition set in advance, the alarm 112c, for example, notifies the user. Notification by the alarm 112c is performed, for example, by causing the display 6 to display that other ultrasound image is arranged or outputting alarm sound.

The arrangement processor 1061c refers to the arrangement position corresponding to the condition set by the condition setting unit 110c upon reception of the determination result from the determination unit 111c, and determines the arrangement position of the ultrasound image determined to match the condition.

In the first modified example of the third embodiment, since the arrangement position for the ultrasound image matched the condition is determined, a new ultrasound image is replaced to arrange at the position even if other ultrasound image has already been arranged. At this time, by notifying the user through the alarm 112c, the user can recognize the replacement of the ultrasound image in the past. After the notification is performed by the alarm 112c, a new ultrasound image may be replaced to arrange at the position on condition that an approval by the user is obtained.

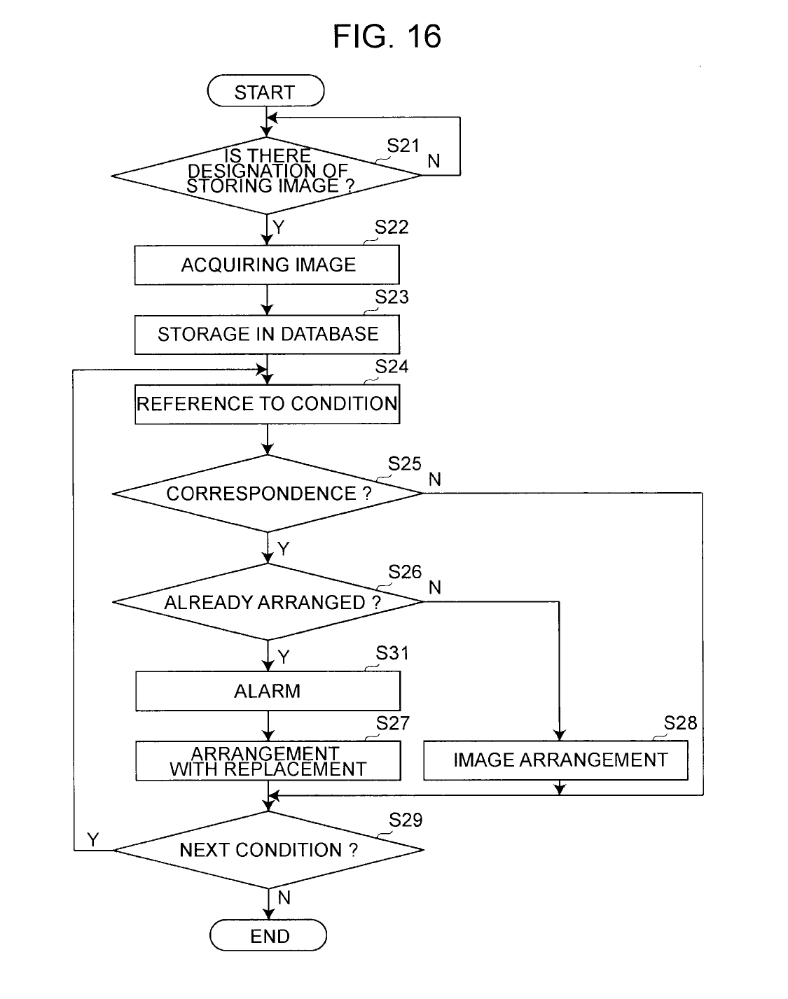

FIG. 16 illustrates a flow diagram of an arrangement processing example of an ultrasound image onto a medical report by the medical image processor according to the first modified example of the third embodiment. In FIG. 16, the same parts as in FIG. 14 are donated by the same signs, and the descriptions are appropriately omitted.

The flow illustrated in FIG. 16 differs from the flow illustrated in FIG. 14 in that step S31 is added. Specifically, the step S31 is added between the step S26 and the step S27. That is, when it is determined that other ultrasound image has already been arranged (step S26: Y) the alarm 112c notifies the user accordingly (step S31). The report generator 1062c then replaces the image with a new ultrasound image which is determined to match the condition in the step S25 (step S27).

As described above, in the first modified example of the third embodiment, in a case that an ultrasound image which matches the condition set in advance is arranged in a medical report, when other ultrasound image has already been arranged, the alarm 112c notifies the user accordingly. Thus, the ultrasound image arranged in the medical report by the user can be prevented from being replaced with other ultrasound image without being noticed by the user.

### Second Modified Example of the Third Embodiment

In the third embodiment or the first modified example thereof, it has been described that an ultrasound image has already been arranged is replaced with a new ultrasound image, however, it is not limited thereto. In a second modified example of the third embodiment, an ultrasound image which has already arranged is linked, and then a new ultrasound image is arranged at the arranged position.

The medical image diagnosis apparatus according to the second modified example of the third embodiment differs from the medical image diagnosis apparatus according to the third embodiment in mainly process contents of the report display processor. Hereinafter, the difference is mainly described.

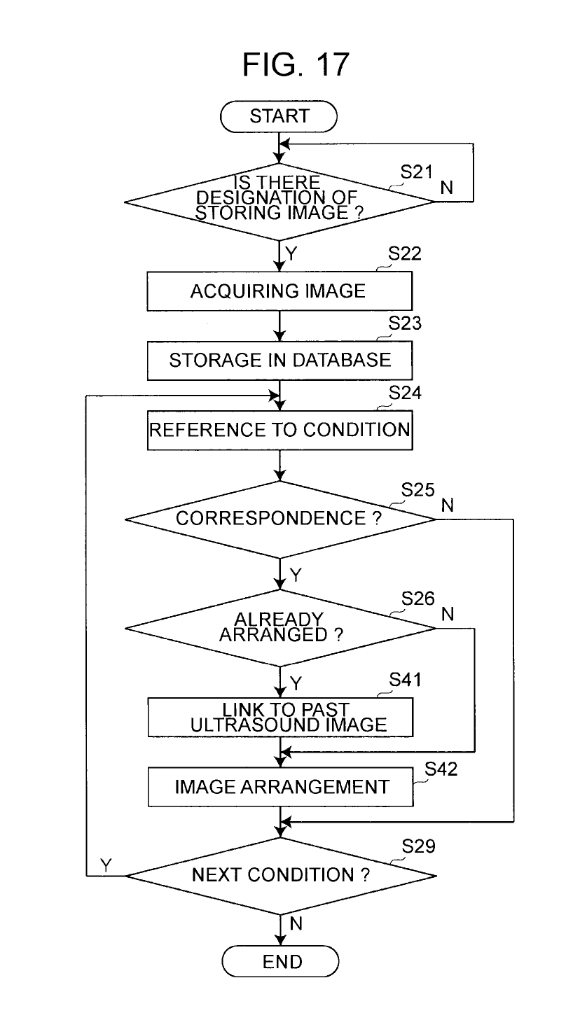

FIG. 17 illustrates a flow diagram of an arrangement processing example of an ultrasound image onto a medical image by the medical image processor according to the second modified example of the third embodiment. In FIG. 17, the same parts as in FIG. 14 are donated by the same signs, and the descriptions are appropriately omitted.

The flow illustrated in FIG. 17 differs from the flow illustrated in FIG. 14 is in that the step S27 and the step S28 are deleted and step S41 and step S42 are added.

That is, when it is determined that other ultrasound image (past ultrasound image) has already been arranged (step S26: Y), the report generator provides a link to the other ultrasound image (step S41). Specifically, the report generator acquires address information for referring to the other ultrasound image, and associates the address information with the link text indicating that the ultrasound image is linked at the arrangement position in a hyperlink format. At this time, the text in a link associated range to which the hyperlink is set is changed in color and underlined to be discriminably displayed.

When it is not determined that other ultrasound image has already been arranged (step S26: N), or subsequently to the step S41, the report generator arranges a new ultrasound image which is determined to match the condition in the step S25 at the arrangement position (step S42).

When it is determined that the image dose not match the condition (step S25: N), or subsequently to the step S29, the medical image processor 10 determines whether or not the next condition is set by the condition setting unit (step S29). When it is determined that the next condition is set (step S29: Y), the medical image processor transfers to the step S24, and continues processing concerning the next condition. When it is determined that there is no next condition in the step S29 (step S29: N), the medical image processor terminates a series of the processing (end).

As described above, in the second modified example of the third embodiment, in a case that the ultrasound image matches the condition set in advance is arranged in a medical report, when other ultrasound image has already been arranged, the other ultrasound image is linked and a new ultrasound image is arranged at the arrangement position. Thereby, a medical report, which is referable as needed, can also be generated for the other ultrasound image linked.

### Fourth Embodiment

In this embodiment, the arrangement processor determines an arrangement position in the image arrangement region corresponding to a type of the designated desired ultrasound image (medical image), and the report generator arranges the ultrasound image at the arrangement position determined by the arrangement processor to generate a medical report. The ultrasound image type is defined by the acquired site (chest, abdomen, or the like). Thus, the report generator can generate a medical report in which the designated desired medical image is arranged in the image arrangement region corresponding to the acquired site.

For instance, an arrangement position in the image arrangement region is predetermined for every acquired site of the ultrasound image. The ultrasound image of a predetermined first acquired site is arranged at an arrangement position in the image arrangement region preliminarily corresponding to the first acquired site, and the ultrasound image of a predetermined second acquired site is arranged at an arrangement position in the image arrangement region preliminarily corresponding to the second acquired site.

Further, the ultrasound image type may also be defined by the acquisition direction of the ultrasound image for each of the acquired sites. Thus, the report generator can generate a medical report in which the designated desired ultrasound image is arranged in the image arranged region corresponding to the acquired site and the acquisition direction of the image.

For instance, an arrangement position in the image arrangement region is preliminarily determined for every acquisition direction of the acquired site of the ultrasound image. The ultrasound image in a first acquisition direction in the predetermined first acquired site is arranged at the arrangement position in the image arrangement region preliminary corresponding to the first acquisition direction in the first acquired site, and an ultrasound image in a second acquisition direction in the first acquired site is arranged at an arrangement position in the image arrangement region preliminary corresponding to the second acquisition direction in the first acquired site. In the same manner, an ultrasound image in a first acquisition direction in the predetermined second acquired site is arranged at an arrangement position in the image arrangement region preliminary corresponding to the first acquisition direction in the second acquired site, and an ultrasound image in a third acquisition direction in the second acquired site is arranged at an arrangement position in the image arrangement region preliminary corresponding to the third acquisition direction in the second acquired site.

Thereby, a medical report in which a medical image is arranged at the predetermined arranged position in the image arrangement region, for every acquisition sites and acquisition directions thereof can be easily generated. The medical image for every predetermined acquired sites and acquisition directions thereof can therefore be easily pasted, and a useful medical report that serves as evidence can be easily generated.

At the arrangement position in the image arrangement region corresponding to the type of the desired ultrasound image, as above embodiment, an ultrasound image may be arranged in designated order of ultrasound images or in order which matches a condition set in advance.

### Other Modified Examples

When other ultrasound image has already been arranged at the arrangement position, by reducing the size of the other ultrasound image, a medical report in which more ultrasound images can be arranged may be generated in the limited image arrangement region.

Further, when other ultrasound image has already been arranged at the arrangement position, by generating a link list linked with the other ultrasound image and displaying the list associating with the arrangement position, a medical report in which more ultrasound images can be arranged may be generated in the limited image arrangement region.

It is possible to arbitrary combine the configurations described in the first embodiment to the fourth embodiment or the modified examples thereof.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A report generation apparatus configured to generate a medical report having an image arrangement region to which medical images are arranged, comprising:
a designation reception unit configured to receive designation of a desired medical image designation from among one or a plurality of medical images acquired by a medical imaging unit;
an arrangement processor configured to determine an arrangement position of the desired medical image in the image arrangement region corresponding to an order of the designation of the desired medical image;
a medical report generator configured to generate the medical report by arranging the desired medical image at the arrangement position determined by the arrangement processor.

2. The report generation apparatus according to claim 1, comprising
a determination unit configured to determine whether or not the desired medical image matches a preset condition, when the designation of the desired medical image is received by the designation reception unit, wherein
when the determination unit determines that the desired medical image matches the preset condition, the arrangement processor is configured to determine an arrangement position of the desired medical image in the image arrangement region corresponding to an order of the designation of the desired medical image.

3. The report generation apparatus according to claim 1, comprising
a determination unit configured to determine whether or not the desired medical image matches a preset condition, when the designation of the desired medical image is received by the designation reception unit, wherein
when the determination unit determines that the desired medical image matches the preset condition, the arrangement processor is configured to determine an arrangement position of the desired medical image in the image arrangement region corresponding to the condition.

4. The report generation apparatus according to claim 3, wherein
a medical image includes at least one object of plural kinds of objects,
the condition is that a medical image includes a pre-registered object.

5. The report generation apparatus according to claim 4, wherein
the object includes at least one of a body mark, an annotation, and a measurement label.

6. The report generation apparatus according to claim 3, wherein
when the designation of the new medical image is received by the designation reception unit with a medical image arranged at a arrangement position for a new medical image, the medical report generator is configured to arrange the new medical image to be replaced with the medical image which has already been arranged.

7. The report generation apparatus according to claim 6, wherein
the medical report generator is configured to link the medical image arranged at the arrangement position.

8. The report generation apparatus according to claim 6, comprising an alarm configured to demonstrate that a medical image has already been arranged at the arrangement position for new medical image.

9. The report generation apparatus according to claim 1, comprising a storage configured to store the desired medical image in response to the designation of the desired medical image received by the designation reception unit.

10. The report generation apparatus according to claim 1, wherein the medical report generator is configured to generate the medical report by arranging the desired medial image at the arrangement position determined by the arrangement processor upon reception of pasting designation from a pasting designation unit that receives the pasting designation of the desired medical image.

11. A report generation apparatus configured to generate a medical report having an image arrangement region to which medical images are arranged, comprising:
a designation reception unit configured to receive a desired medical image designation from among one or a plurality of medical images acquired by a medical imaging unit;
an arrangement processor configured to determine an arrangement position of the desired medical image, which is received by the designation reception unit, in the image arrangement region corresponding to the medical image type;
a medical report generator configured to generate the medical report by arranging the desired medical image at the arrangement position determined by the arrangement processor.

12. The medical report generation apparatus according to claim 11, wherein
the medical image is an ultrasound image,
the medical image type is defined by a site where the ultrasound is acquired.

13. The medical report generation apparatus according to claim 12, wherein the medical image type is further defined by a direction of the ultrasound image to be acquired.

14. A medical image diagnosis apparatus, comprising:
the medical report generation apparatus according to claim 1;
a designation unit configured to receive a desired medical image; and
the medical imaging unit.

15. A medical image diagnosis apparatus, comprising:
the medical report generation apparatus according to claim 11;
a designation unit configured to receive a desired medical image; and
the medical imaging unit.
